(19) United States
(12) Patent Application Publication
(10) Pub. No.: US 2010/0042485 A1
(43) Pub. Date: Feb. 18, 2010

(54) ADVERTISEMENT DELIVERY SYSTEM

(75) Inventors: Yiqing Wang, Bothell, WA (US); John Dietz, Redmond, WA (US); Vas Sudanagunta, Seattle, WA (US); Peter Wickersham, Seattle, WA (US)

Correspondence Address: DORSEY & WHITNEY LLP;on behalf of Disney Enterprises, Inc., 370 17th Street, Suite 4700, Denver, CO, 80202-5647, US

(73) Assignee: Disney Enterprises, Inc., Burbank, CA (US)

(21) Appl. No.: 12/191,207

(22) Filed: Aug. 13, 2008

(51) Int. Cl. G06Q 30/00

(52) U.S. Cl. 705/14.5

(57) ABSTRACT

An advertisement delivery system for internet advertising is provided. The system comprises an ad server in functional communication with a delivery engine capable of delivering an advertisement to a web server for display in a webpage in response to a triggering event by an internet user. A configuration module may be provided in functional communication with the delivery engine. The configuration module may be adapted to schedule an advertisement for delivery by the delivery engine. The configuration module may also be capable of communicating the advertisement to the delivery engine according to the schedule. The configuration module may have a schedule of advertisements for display in a defined period of time. The advertisement delivery system also may include a means for calculating in real time internet traffic flow and means for adjusting the schedule of delivery of advertisements based upon the internet traffic flow. A method of advertisement delivery for internet advertisements is also disclosed.

### SCOPE OF THE INVENTION

The present invention relates to advertisement delivery systems and methods, and in particular advertisement delivery systems and methods for use with internet advertising.

### BACKGROUND

Internet or online advertising is well known and has become a commonly used advertising medium. Users who browse the Internet, or visit a specific website are often confronted with webpage advertisements, such as display ads, including for example, banner ads, skyscraper ads, and in-content ads. Various systems have been developed to deliver these advertisements to users.

Advertisers who use this web-based medium of advertisement are confronted with a number of pricing models. For example, in the cost-per-thousand or CPM pricing model, the advertiser pays a fixed amount to the publisher every time an advertisement is displayed. Typically, in this scenario advertisers assume all or a majority of the risk, as the publisher is guaranteed revenue per impression regardless of the effectiveness of the advertisement. Performance-based models also exist. In these models, some or most of the risk is placed on the publisher, as the advertiser pays the website only when a customer takes some action in response to the advertisement. Common examples of performance-based models are a fixed amount per click, a fixed amount per purchase, or a fixed percentage of the purchase price for each purchase.

Due to the relatively high level of risk in both models, advertisers and publishers or website operators desire to maximize revenue by directing advertisements to consumers who are likely to purchase the particular product or service advertised. Thus, advertisements are targeted to consumers with specific characteristics. Targeting of advertisements is well known and occurs, generally, by identifying or characterizing a demographic of consumers most likely to be a consumer of the product or service, and delivering the ad to that characterized group or individual. Targeted advertisements may be sold at any time to advertisers. Targeted advertisements may be used by publishers to free up advertising space, as the advertisements are not blanketed across the internet or several internet sites, but instead are strategically delivered at specific moments based upon certain triggering events or parameters. Moreover, targeted advertisements are more expensive. Thus, there is an incentive for sales teams to sell targeted advertising.

Advertisers typically desire to deliver a specific number of impressions of the advertisement to the targeted consumer and often enter contracts with the publisher to achieve this goal. Unfortunately, targeted advertisements, because of the numerous parameters involved in targeting the advertisement, are difficult to forecast, as internet traffic flow can vary widely. In light of the numerous variables involved in internet advertising, a common problem is that it is easy to sell advertising space beyond the available capacity of the site or under the capacity of the site. As a result, advertisements are often over-sold or over-delivered, costing either the advertiser or the entity serving the ads money. Thus, advertisers risk paying for advertising space which is never filled and owners of ad space or publishers risk not fulfilling their contractual obligations as well as underselling, and thus not maximizing the revenue from a particular website.

Accordingly, what is needed in the art is an advertisement delivery system that dynamically delivers advertisements and can adjust to internet traffic fluctuation.

### SUMMARY

An advertisement delivery system for internet advertising is provided. The system comprises an ad server in functional communication with a delivery engine capable of delivering an advertisement to a web server for display in a webpage in response to a triggering event by an internet user. A configuration module may be provided in functional communication with the delivery engine. The configuration module may be adapted to schedule an advertisement for delivery by the delivery engine. The configuration module may also be capable of communicating the advertisement to the delivery engine according to the schedule. The configuration module may have a schedule of advertisements for display in a defined period of time. The advertisement delivery system also may include a means for calculating in real time internet traffic flow and means for adjusting the schedule of delivery of advertisements based upon the internet traffic flow.

A further advertisement delivery system for internet advertising includes an ad server in functional communication with a delivery engine capable of delivering an advertisement to a web server for display in a webpage, and a configuration module in functional communication with the delivery engine. The configuration module may be adapted to schedule an advertisement for delivery by the delivery engine. The configuration module may also be capable of communicating the advertisement to the delivery engine according to the schedule. The configuration module assigns a first set of advertisements to a first priority list and assigns goals for delivery to the first set of advertisements. The configuration module assigns at least a second set of advertisements to a second priority list and assigns goals for delivery to the second set of advertisements, wherein the first set of advertisements is adapted to be delivered before the second set of advertisements.

A further advertisement delivery system for internet advertising is provided. The system comprises an ad server in functional communication with a delivery engine capable of delivering an advertisement to a web server for display in a webpage in response to a triggering event by an internet user and a configuration module in functional communication with the delivery engine. The configuration module may be adapted to schedule an advertisement for delivery by the delivery engine. The configuration module may also be capable of communicating the advertisement to the delivery engine according to the schedule. The configuration module may have a schedule of advertisements for display in a defined period of time. The delivery engine may be arranged to calculate in real time internet traffic flow and communicate with the configuration module to adjust the schedule of delivery of advertisements based upon the internet traffic flow.

A method of advertisement delivery for internet advertising is also disclosed. The method comprises obtaining a plurality of advertisements for delivery in response to a triggering event by an internet user. The method further includes assigning goals for allocation of a first set of advertisements in relation to the triggering event, assigning goals for allocation of a second set of advertisements in relation to the triggering event, and assigning a priority to advertisements in the first set of advertisements. Upon receiving a request for delivery of an advertisement, the method involves selecting an advertisement for delivery based upon a goal of the advertisement, a priority for the advertisement and internet traffic flow. Then, the selected advertisement is delivered.

A further method of advertisement delivery for internet advertising is disclosed. The method includes assigning a minimum number of impressions of a plurality of advertisements to be delivered based upon user request, assigning a maximum number of impressions to a plurality of advertisements to be delivered based upon user request, delivering impressions of advertisements in response to a triggering event by an internet user to meet the minimum number of impressions, and terminating advertisement delivery based upon reaching the maximum number of impressions.

In an exemplary embodiment of the advertisement delivery system and method described, the advertisement delivery system may maximize usage of available advertisement space and adjust for low or below predicted levels of internet traffic to deliver advertisements according to business preferences. In other words, the system and method may minimize risk associated with overestimates of internet traffic flow and may take advantage of high internet traffic volumes to, for example, increase revenue. More specifically, an exemplary embodiment of the advertisement delivery system can assist in fulfilling contractual obligations or guarantees for ad delivery and effectively use the advertising space available. The system interacts, in real time or near real-time, at the delivery engine level to direct, establish, and monitor internet traffic flow and availability of advertisements with a level of precision. The system with the foregoing components enhances the effective use of available online advertising space. Other advantages and features may become apparent from the following description, drawings, and claims.

### BRIEF DESCRIPTION OF THE DRAWINGS

FIG. 1 is an exemplary internet webpage showing representative advertisement placement locations.

FIG. 2 is a flow chart illustrating the flow of information in an exemplary internet advertising system for use with the present invention.

FIG. 3 is a flow chart illustrating the flow of advertisements in response to a user request in an exemplary internet advertising system for use with the present invention, absent the ad server and web server.

FIG. 4 is a flow chart illustrating the scheduling of advertisements for delivery.

FIG. 5 is a flow chart illustrating the determination of a priority level shown in FIG. 4.

FIG. 6 is a partial functional flow diagram illustrating decisions made by an embodiment of the advertisement delivery system in response to a request.

### DETAILED DESCRIPTION

The invention is generally directed to an advertisement delivery system for use with internet advertisements. More specifically, the present invention is a system for the delivery of advertisements available for online display when requested by a webpage, such as a homepage. The system is generally used to deliver advertisements to be displayed on one or more webpages.

The delivery system delivers ads in the form of advertising impressions to devices that may be operatively connected, or intermittently connected to a network. The delivery of an advertisement or advertisement content to a user in an embodiment of the present invention generally includes the selection of the advertisement as it relates to current and forecasted advertisement inventory, targeting parameters, the contractual obligations for display of advertisements, and the flow or volume of internet traffic to a website. The delivery system may be configured to operate in real time.

The system herein may be operated by computer-executable instructions, such as program modules, executable on a computer. Program modules may include routines, programs, objects, components, data structures and the like which perform particular tasks or implement particular instructions. The computers in association for use with the system and various components described herein may be programmable computers which may be special purpose computers or a general purpose computers that execute the system according to the relevant instructions. Other computer system configurations may also be acceptable, including hand-held devices, cell phones, PDAs, mobile devices, multiprocessor systems, microprocessor-based or programmable electronics, network PC's, minicomputers, mainframe computers, and the like. Preferably, the computing system chosen includes a processor suitable in size to efficiently operate one or more of the various systems or functions of the invention. The system or portions thereof may also be linked to a distributed computing environment, where tasks are performed by remote processing devices that are linked through a communications network. To this end, the system may be configured or linked to multiple computers in a network, including, but not limited to a local area network, a wide area network, a wireless network, and the Internet. Therefore, information and data may be transferred within the network or system by wireless means, by hardwire connection or combinations thereof. Furthermore, the computer or computers may be operatively or functionally connected to one or more mass storage devices, such as, but not limited to a database. The system may also include computer-readable media which may include any computer readable media or medium that may be used to carry or store desired program code that may be accessed by a computer.

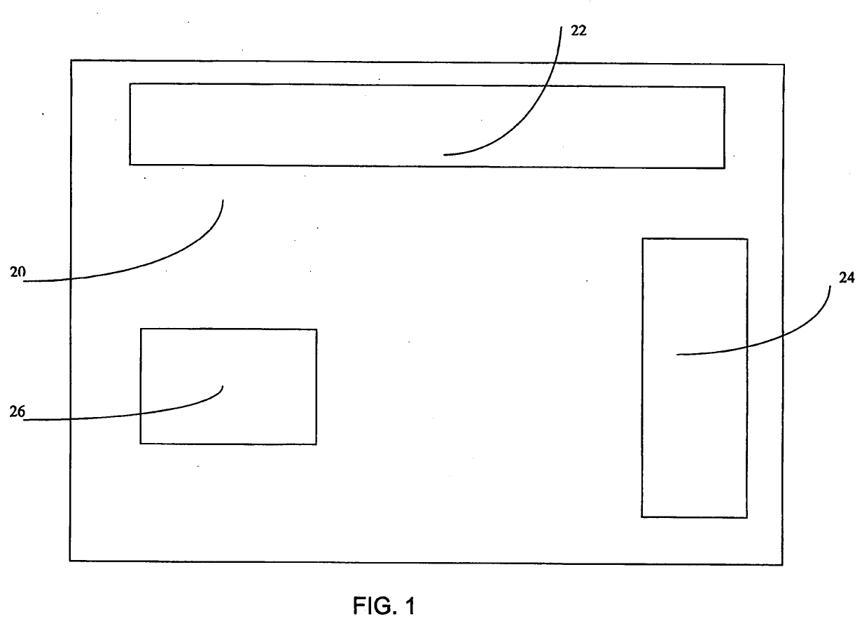

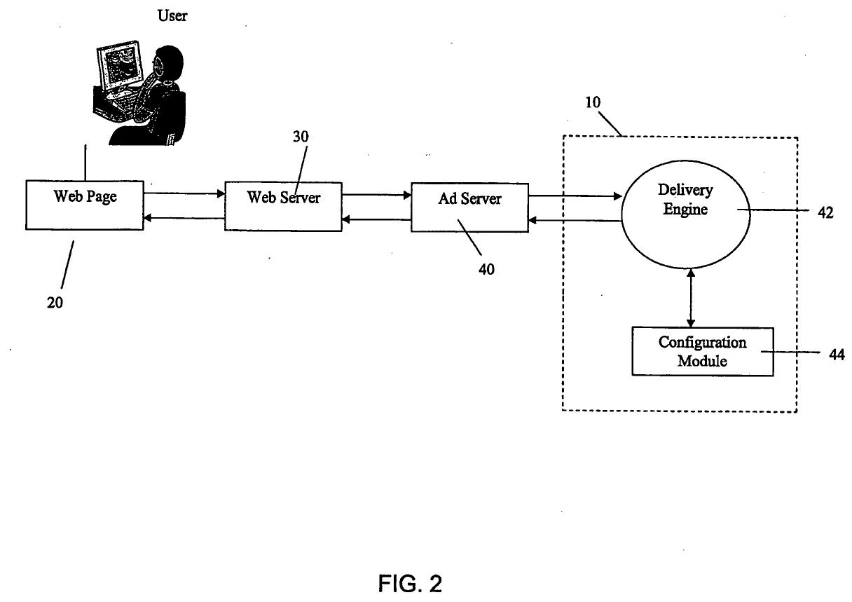

The advertisement delivery system 10 (FIG. 2) is suitable for use in delivery of advertisements with various internet advertising systems, including but not limited to, traditional online advertising systems, cell phone advertising systems, online streaming video systems or video advertisements, and even off-line advertising systems. In such systems, advertisements are displayed in or on a webpage in association with the webpage content. A sample internet webpage 20 is provided in FIG. 1, illustrating common placement locations of advertisements. Advertisement locations in FIG. 1 include a banner advertising location 22, a skyscraper advertising location 24, and an in-content advertising location 26. These advertising locations may include one or more advertisements. Each of these advertising locations constitute a space which may be sold to internet advertisers. Furthermore, typical internet advertising systems serve ads, which may be new ads, each time the webpage is accessed or refreshed. Thus, the webpage includes changeable ad content and may result in one or more impressions per visit to the webpage. Each impression, charged as CPM, of an ad may likewise be sold to internet advertisers. Advertising space may also be sold based upon click-through counts.

A portion of an exemplary internet advertising system for use with the advertising delivery system 10 is shown in FIG. 2. The webpage is accessed by a user. A user or internet user may use any system or device which may be connectable to the internet for access thereto, including, but not limited to personal computer, mobile phones, PDA, MP3 player, and the like. Generally, these devices include a graphical user interface (GUI) or a communication means by which an advertisement may be displayed or communicated. The user accesses the internet by this device and typically visits a website or webpage. When a user visits a particular website or webpage, a user essentially requests a particular page, such as a homepage. The request is provided to a web server to render this page. The images scheduled for that page at that particular time and day may be rendered to the user. The content of the webpage 20 and contact or access by a user of the webpage is generally managed by a web server 30. The web server 30 is in functional or operable communication with an ad server 40, such that it may exchange information or data with the ad server 40. To this end, the web server 30 may request an advertisement from the ad server 40 to be displayed on the webpage 20 in response to a user contact or selection on the webpage. Alternatively, the browser or webpage 20 may also request a page from the web server 30, then on receipt, may directly request one or more ads from the ad server 40 such that communication of the ad may be from or between webpage 20 and ad server 40. The foregoing systems are generally referred to, respectively, as server-side ad serving and client-side ad serving. The ad server system may or may not be inside the web server. When a web server is rendering the page, a request is made to the ad system server. The request may be specific, such as for a specific format or type of advertisement, such as a banner advertisement, for display on the webpage, or may be a general request. The advertisement may be a static advertisement, such as a picture or text advertisement, or may include or be formed of an audio component. Advertisements acceptable for use with the present invention also include video streaming, video online advertising, off-line advertising, and stored presentations such as a download onto a computer or other portable device. While any combination of ads may be available, a finite number of advertisements are provided for use on a given webpage based upon the type of advertisement, the number of advertising spaces and the number of hits or requests by a user who visits that webpage.

In response to the request to the ad system server 40, an advertisement is delivered to the web server 30 for display in the particular advertising space that meets this request. The web server 30 may then arrange the ad for placement in one of the advertising locations 22, 24, or 26 in the webpage. In particular, one advertising location may be provided for each advertisement on a webpage. More specifically, a delivery engine 42 of the ad server 40, which may be a dynamic engine, may be used to interact with the user to deliver the advertisement or advertisements in response to user actions. The delivery engine 42 may be a part of the web server, or may exist as a separate component. The ad server 40 or delivery engine 42 determines which advertisement to serve or deliver given the context and parameters of the requester and any pre-defined parameters.

The system may often have multiple advertisements, which are associated with the contracts, available, scheduled or ready for delivery. To determine which advertisement to display, the ad server 40 of an exemplary embodiment may look to the advertisement inventory, which may include the contractual obligations and available imagery for display as an advertisement. The ad server 40 may also review the properties related to the particular user based upon the request, or other gathered or stored information based upon previous activity. In an exemplary embodiment, a website or third party sales force sells advertising space or more specifically, impressions, on one or more internet websites or webpages. Advertisers may deliver the ad content to be included in and delivered by the system to the advertising space, or may request that advertisements be prepared for them. Sales of advertising space typically involve contractual obligations between the website or publisher and the advertiser. Contracts for advertising space may often include a guarantee, such as, but not limited to, regarding a number of impressions to be delivered, dates and times for delivery, and so forth. The contract may also require a targeted delivery. Contracts may require an advertisement to be targeted based upon any number of parameters which are entered into the system. However, each contract may be unique, having different terms, term lengths, and other requirements. While specific examples are provided, the variables associated with the contract terms may vary greatly. Advertisers may request that advertisements be targeted to specific consumers or users. Likewise, target criteria may include the number of impressions per unit of time, or may be based, for example, on an algorithm for relative values established by either the system or the advertiser. As one example, the advertiser may request that advertisements be delivered only at noon on Tuesday, not at noon on Wednesday. Target properties or parameters may be defined by the contract, or may be pre-defined properties that the contract must fit within. In addition to the identified properties in a contract, specific values for these properties may be identified for targeting by the advertiser.

Targeted internet advertising systems are capable of using any suitable parameter or criteria for targeting an advertisement. The criteria or parameters may relate to the subject matter of the website and may also relate to a user, and therefore may be dynamic or static in nature. Each user may have many properties. For instance, a registered user may be known to the system and data may be stored in the system related to that user. The system may also determine, based upon IP address and other factors, the location of the user, such as the country, state, and city of the user. It may also look to behavior or webpage requests made by that particular user to determine properties. In addition to the foregoing, exemplary targeting criteria include, but are not limited to, a country, a state, a metro location, a time of day or time period, subject matter such as website specific subject matter, and user segmentation which may include generally any property of the user and his/her behavior. Likewise, targeting criteria may include the number of impressions per unit of time, or may include an algorithm for relative values.

Generally, an advertisement, or advertisements, selected for delivery are delivered by the delivery engine 42 to the ad server 40, which serves the ad to the web server 30. Alternatively, the delivery engine 42 and ad server 40 may provided in a combined arrangement such as a single module which module may deliver the ad to the web server 30. The advertisement may then be placed inside of that webpage 20 for that mark up language, e.g., HTML, XML, etc., and it may return that webpage with advertisement for rendering to the user. More specifically, as can be seen in FIG. 2, the ad server 40 may include or operably communicate with a delivery engine 42 that operates with a configuration module 44 to deliver advertisements.

The configuration module 44 handles various data and information and assists in maintaining the speed of the system. The configuration module 44 is adapted to receive information from an inventory system (not shown) and a sales system (not shown) and configure the information into a useable form. For example, based upon the relevant properties and data from the contractual obligations, the inventory system may determine which advertisements that are sold match the internet user and any relevant targeting properties. A decision is then made based on the relevant properties as to what advertisement to deliver. In an exemplary embodiment, the configuration module 44 provides the delivery engine 42 information about what is going to happen in a given time period, for example, in a given hour. The configuration information may be based on the forecast capacity of inventory, the sold data which includes sold advertisements, and any data related to the targeting parameters of the advertisement.

As indicated, the delivery engine 42 operates with a configuration module 44 to arrange advertisements for delivery. The configuration module 44 may be a static mechanism that operably or functionally communicates to the delivery engine 42 everything that is possible to be delivered to the particular webpage for that time period. In this regard, the configuration module 44 is adapted to provide a schedule of planned advertisements for delivery based upon user requests or triggering events, such as, but not limited to website visits. In the exemplary embodiment described herein, the configuration module 44 may be dynamic, changing the delivery schedule in response to user actions, and in response to or in connection with internet traffic flow. Accordingly, in a dynamic system, the system may be designed to answer requests for advertisements dynamically, based upon internet traffic to a particular site and based upon other criteria, such as, but not limited to targeting parameters that correspond to users who request the site.

Using the information provided, the configuration module 44 develops a schedule of planned advertising to be applied by the delivery engine 42 in response to user request. The schedule includes a plurality of advertising spaces for delivery of advertisements based upon a variety of circumstances, including, but not limited to, targeted delivery of advertisements.

Advertising space may be determined based upon the internet websites or pages associated with the system and number of advertising locations associated with each page. The number of advertisements may be further determined by forecasting internet traffic associated with each site or page. Forecasted traffic may be determined by reviewing historical data (such as over a pre-defined time period) and projecting out into the future, often for a time period, to determine the advertising capacity. In an exemplary embodiment, the system may review historical data, such as an internet traffic pattern within a given time period, for a given website or more specifically a webpage and any target parameter, and may project into the future a period of time. For example, the system may project eighteen months ahead of time. Many parameters may be involved in this analysis, including the overall growth for internet traffic, how well the website has done in the past, particular events past and estimated or anticipated future events, targeting criteria, and so forth. These parameters may be assembled together, analyzed for patterns, and used to project possible traffic flow. Current traffic flow may be based upon the number of “hits” received by a particular website, or the number of impressions delivered, and other suitable means. In addition, the delivered impressions may include targeting parameters such as, but not limited to, geographic source of the impressions, time of day of the impressions, source domain of the impressions, and so forth. In one exemplary embodiment, the current traffic flow may be determined based upon any one or any combination of these properties or parameters.

Sold contracts for delivery of advertisements, and thus advertisements themselves, may be matched to target parameters and also the forecast capacity. Thus, a scheduled number of advertisements or impressions may be planned for delivery on a particular day as well as at a given time by the configuration module 44.

As is understood, internet traffic flow is difficult to predict. Thus, a spike or increase in traffic flow over the anticipated or predicted amount may occur. As one example, an unexpected or unanticipated news event may occur on a particular day, resulting in an increase in users who visit a particular news content website. The increase in users or visitors may exceed the predicted internet traffic flow for that time period. In the exemplary embodiment, the configuration module 44 may have scheduled a planned number of advertisements or impressions to be delivered to that site for that day or time period. Due to the spike in internet traffic to the website, additional opportunities exist to deliver advertisements or impressions to the additional users who visit the site. Similarly, the number of users who visit a website on a given day or at a particular time may be low, or below the planned number of advertisements or impressions anticipated for the site. As a result of the decrease in users, all the advertisements scheduled for that day or time will not likely be served. Thus, a decision may be made to deliver certain selected advertisements, which ultimately, may minimize risk to the advertiser and publisher of the ad.

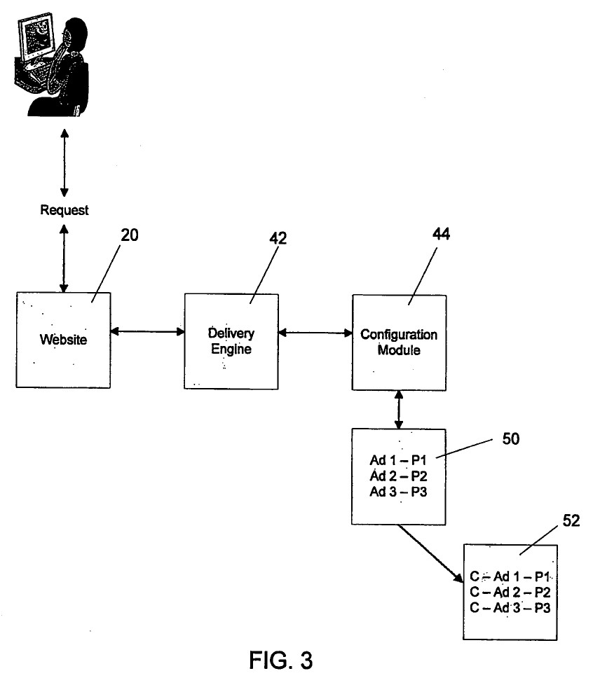

Referring generally to FIGS. 3-5, the delivery engine 42 may dynamically deliver advertisements based upon fluctuations in internet traffic flow or deviations in traffic flow from the predicted or forecasted amount. The delivery engine 42 operates in real time, or near real time, to adjust or control the advertisements delivered in the event of the traffic spike or to address an overestimate of internet traffic flow, such as may occur with low traffic volume. In an exemplary embodiment, the delivery engine 42 uses assigned goals and the allocation of advertisements to deliver ads to the web server for display to the user on the website 20.

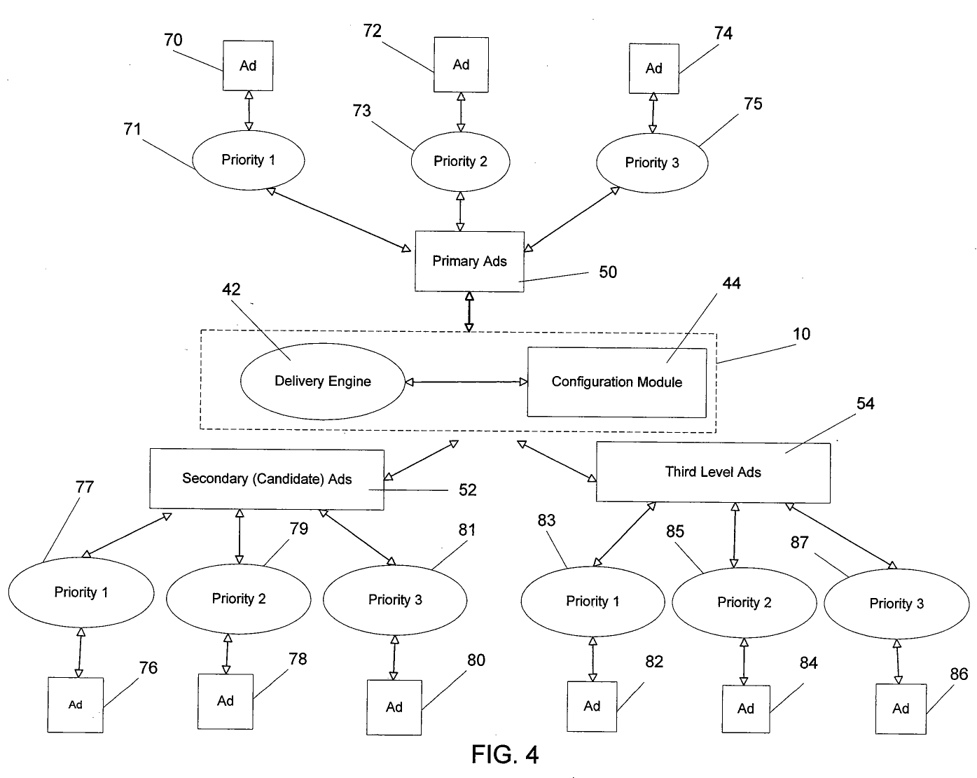

In order to schedule advertisements for delivery, the advertisements are assigned a priority or goals for delivery and are allocated for delivery based upon certain parameters. In this regard, as can be seen by reference to FIG. 4, one or more advertisement categories 50, 52, and 54 may be provided, each having its own goals or arrangement or priority logic for scheduling advertisements (see FIGS. 3-4). Algorithms may define which ads to deliver and may be calculated in real time or near real time by the delivery engine. For example, based upon priorities assigned to particular advertisements or particular contracts, the system may fulfill one advertisement or contract guarantee first.

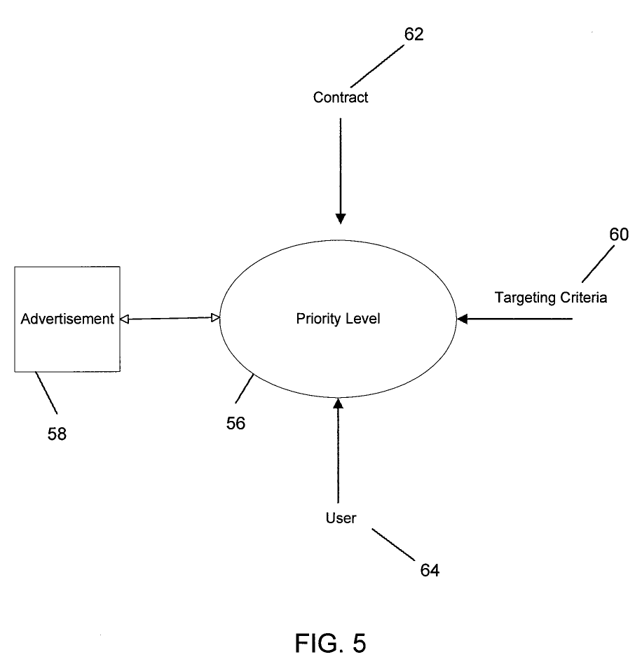

Priority may result from a variety of parameters and circumstances. Priority may be assigned by any means suitable to the advertiser or advertisement system administrator or the like. Generally, referring to FIG. 5, a priority level 56 may be assigned to an advertisement 58 based upon forecast capacity of targeting parameters or criteria 60 and processing of sold advertisements or contracts 62 which may be ranked with priority, and allocation for delivery to intended users 64. More specifically, once future capacity is forecasted, an advertisement guarantee or campaign based upon the contract may be mapped to particular targeting parameters or targeting criteria 60 and associated with a particular advertisement 58, or allocation of a particular advertisement for delivery under certain pre-defined parameters may also occur. Advertisements of an exemplary embodiment may also be optimized for delivery. The optimization process bases a decision of which ad to deliver upon criteria or parameters such as price, inventory level, and priority. Additional parameters may be used based upon advertiser or publisher/website owner purposes. Advertisements may also be ranked according to priority based upon the contractual terms. Priority may be assigned manually or by automated means and may be based on, for example, contractual obligations or business goals.

An example of a possible priority decision (referring to FIG. 5) may include one contract 62 that may contractually require the advertisement to be scheduled over a period of time, in which case the system may pace the advertisement delivery appropriately. Thus, a contract may require an advertisement to be delivered a number of times over a period of three months. Within this three months, a flat amount of advertisements must be delivered every day to meet the guarantee in the contract. Thus, a goal for delivery of an ad 58 is set. Accordingly, the advertisement or impressions associated with this contract may be given higher priority 56 over a contract having an unrestricted delivery time period. In an alternative, a contract 62 may require, based upon targeting criteria 60, delivery to certain limited users. In this event, the advertisements 58 associated with this contract may be given higher priority 56 for delivery upon the event that the user 64 meeting the targeting criteria makes the request than a contractual obligation that does not require such specifics. In a third example, a contract 62 may be of a higher dollar value (or other perceived value) than a second contract, in which case, the higher dollar value contract may be given higher priority 56 for the delivery of impressions than the second contract. The foregoing examples are provided for purposes of illustration only, and other suitable criteria for prioritizing the delivery of advertisements may be used without departing from the overall scope of the present invention.

As shown in FIG. 4, the configuration module 44 includes a schedule of planned advertising for delivery by the delivery engine 42 of the advertisement delivery system 10. As indicated, the configuration module 44 may include a first schedule of planned advertising based upon predicted traffic flow, as can be seen in FIG. 3, by reference to the schedule 50 of Ads 1, 2 and 3 and schedule 52 of C-Ads 1, 2, and 3. Referring to FIG. 4, a first schedule of primary advertisements 50 forms a first category of advertisements assigned for delivery by the delivery engine 42 of the advertisement delivery system 10. Primary advertisements 50 may include advertisements associated with contractual obligations, and may include those contracts associated with, for example, a value. These primary advertisements 50 may also be scheduled for delivery according to certain targeting criteria, and thus may have particular parameters that must be met for the advertisement to be delivered. For instance, the system may operate with a target number of impressions or a limitation on the number of impressions or a limitation in regards to how or to whom the ad is delivered.

Within the first category 50 of advertisements, the advertisements 70, 72, and 74 may also be arranged for delivery according to a priority (see FIG. 4). For example, using the illustrated example shown in FIG. 5, an advertisement 70 for company 1 may be given higher priority (i.e., Priority 1 (71) in FIG. 4) and thus be delivered before an advertisement 72 for company 2 (i.e., Priority 2 (73) in FIG. 4) based upon targeting parameters assigned to that advertisement, and/or a user, or the number of impressions that must be delivered for company 1 and so forth. Likewise, the advertisement 74 for company 3 may be given lower priority (i.e., Priority 3 (75) in FIG. 4) in view of the advertisements 72 and 70 for companies 2 and 1.

In the event of a traffic spike or “spill-over” of internet users beyond the predicted number of internet users, a pipeline of available advertisements may be available which can be delivered at any time. These ads may be applied in the configuration module 44 of the advertisement delivery system 10. In each segmented time period, for instance, each day may have certain impressions available which are free or may be used in any way. To this end, a second category 52 or level of advertisements is queued for delivery or applied in the configuration module 44 for delivery by the delivery engine 42 of the advertisement delivery system 10. The second category 52 may include or form candidate advertisements (see FIGS. 3 & 4). Candidate advertisements 52, for the purposes provided herein, may include any suitable ad, including but not limited to, wholesale advertisements sold in bulk, leftover advertisement inventory, low price advertisements, and make-over deals. For example, in some instances, a contract or guarantee for delivery of impressions may not be fulfilled. In other words, the number of contracted impressions is not delivered in the guaranteed time period. In exchange, these undelivered impressions, or an alternative or additional number of impressions, may be delivered, contractually or otherwise, within a new time period, often times for free or for a reduced fee, to accommodate the unsuccessful completion of the original contractual obligation. These make-over deals or advertisements may be included as candidate ads. Likewise, advertisements that can be delivered at any time, or have no or very few restrictions on delivery may be used as candidate advertisements.

Referring to FIGS. 3 & 4, candidate advertisements 52 may be given second priority to the primary advertisements 50 (see FIG. 3). In other words, candidate ads 52 are served by the delivery engine 42 only when all primary ad 50 goals are met for the time period. Additionally, within the possible advertisements 76, 78, 80 that may be delivered as candidate advertisements, a ranking or priority may be assigned for delivery according to a particular schedule or order, which may be used, for example, to fulfill goals associated with the candidate ads and other purposes determined by the website or advertising company (see FIG. 4). In this regard, candidate advertisement 76 may be assigned a higher priority (i.e., Priority 1 (77) in FIG. 4) in the configuration module 44 than candidate advertisement 78 (i.e., Priority 2 (79) in FIG. 4). Candidate ad 80 may have lower priority (i.e., Priority 3 (81) in FIG. 4) than candidate advertisements 76 and 78. Thus, as with the primary advertisements 50, candidate ads 52 may be prioritized such that Ad 1 has higher priority than Ad 2, Ad 2 has higher priority than Ad 3, and so forth, so that Ad 76 is served before Ad 78, and Ad 80 is served after Ads 76 and 78 by the delivery engine 42.

A third category or third level 54 of advertisements may be provided (see FIG. 4). The third level 54 may include any number advertisements that can be scheduled for delivery, or obtained from third-party entities for delivery. The third level advertisements 54 may be scheduled for delivery by the delivery engine 42 after the goals of the second level or candidate ads 52 have been met, and thus would have or be assigned lower priority in the configuration module 44 to the candidate ads 52 and the primary ads 50. Like the previous two categories, these third level advertisements 54 may each be assigned a priority in the configuration module 44 for delivery by the delivery engine 42 of the advertisement delivery system 10. As shown in FIG. 4, the third level advertisements 54 include advertisement 82 which has a first priority 83, advertisement 84 which has a second priority 85 and advertisement 86 which has a third priority 87. Thus, Ad 82 would be served before Ad 84, and Ad 86 would be served after Ads 82 and 84. In addition to the third level of advertisements 54, any number of levels or categories of advertisements may be similarly available and scheduled for delivery as described herein, including, for example, fourth, fifth, sixth, seventh categories and so forth. Likewise, while specific examples are given, any number of advertisements and priority thereof within each category may be arranged for delivery without departing from the overall scope of the present invention.

Any number of advertisement selection strategies may be used to determine which advertisements should be delivered at which time and to which user. In an exemplary embodiment, the advertisements may be used in association with a targeted advertising system. In this regard, advertisements may be allocated to be delivered based upon targeting parameters. Additionally or alternatively, the advertisements may be assigned a priority.

Thus, in operation, in a traffic spike situation, a greater number of impressions may be available than scheduled for delivery at the particular time or on a particular day. In this situation, the advertisement delivery system, and in particular, the delivery engine 42 delivers the advertisements 50 scheduled for delivery according to the schedule of planned advertising provided by the configuration module 44 and delivered to the delivery engine 42 of the advertisement delivery system 10. The delivery of scheduled advertisement may or may not occur according the assigned priority. Once the scheduled primary advertisements 50 are exhausted, or goals are fulfilled, the delivery system 10 may turn to additional advertising available for delivery. Using the examples provided herein, the system may use candidate advertisements 52, as well as third level advertisements 54 depending upon the volume of traffic flow and the number of available advertisements in each category to deliver advertisements for the remainder of the time period. As each of the categories of advertisement may be ranked with a priority as described herein, the candidate ads 52 may have higher priority for delivery than the third level ads 54. In this regard, once the primary advertisements 50 are exhausted, candidate advertisements 52 may be delivered to the users based upon requests received, followed by third level advertisements 54. Furthermore, each of the candidate ads 52, such as ads 76, 78, 80, may also be assigned a priority for delivery, and each of the third-level ads 54, such as ads 82, 84, 86, may be assigned a priority for delivery. Therefore, in response to user requests, the system may be able to determine which advertisement to deliver and in which order. It is noted that primary, candidate or secondary, and third level or tertiary ads are used herein for purposes of example only and any number of advertisement categories or levels and labels therefore may be used without departing from the overall scope of the present invention.

In operation, the advertisement delivery system 10 may also manage delivery of advertisements when it may be determined that the delivery goals are not met or may not be met. In other words, the system will not deliver all of the advertisements that are scheduled for delivery. In this situation, the advertisements scheduled for delivery may be delivered according to their priority so that the system can attempt to reach the assigned goals and allocation of advertisements. Accordingly, the impressions available for delivery to a particular user from the primary list 50 are reviewed for priority, and the available advertisement or impression with highest priority is delivered.

The advertisement delivery system 10 may also take a snap shot or review the ads delivered and remaining to be delivered at a particular point in time. For example, in an hour, the system may review the progress or performance of delivery and the internet traffic flow at any time within the hour, such as, but not limited to, for example at 30 minutes. Upon review, the system may analyze the number of impressions delivered and remaining to be delivered, in other words, whether goals have been or may be met, and may make an assessment of the advertisements to be displayed based upon requests received. In a situation of a traffic spike or likely traffic spike, the system may arrange for additional advertisements to be delivered from additional advertisement categories once the goals have been reached by the primary advertisements. In the alternative, when the system determines that, based upon traffic flow, the assigned goals may not be met, the system may arrange for delivery of advertisements in a manner that, for instance, maximizes the delivery of advertisements or delivers the higher priority advertisements. In one further alternative embodiment, the system may perform one or more functions in advance. For instance, the system may arrange for delivery multiple advertisements in advance of request, including one or more advertisements from the second, third, and/or additional categories. These additional advertisements may be scheduled for delivery by any suitable means. In one further alternative embodiment, existing advertising may be reassigned to accommodate a proposed contract. This accommodation may also occur because of a demand for display from users, such as a spike, or other internet traffic issue.

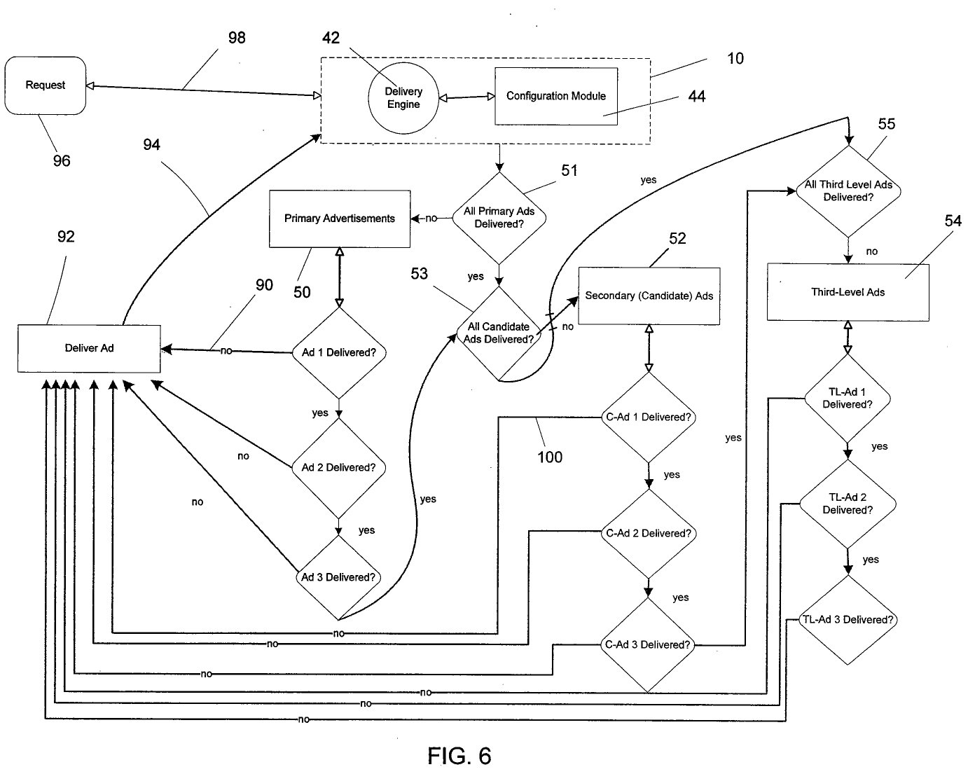

To illustrate the logic of the advertisement delivery system 10, FIG. 6 shows a functional flow diagram of the system including decisions to be made thereby to determine advertisements which may be delivered. For ease of understanding, a simplified illustration of the flow diagram that has been illustrated in some detail, and a limited numbers of features have been identified. However, any number of the features described herein may be inserted and used in the same manner in the order described herein. Likewise, the website, web server and ad server have been omitted for ease of reference. Upon receipt of a request from a user, the delivery engine 42 and configuration module 44 operate to determine which advertisement to deliver. In the illustrated example, the delivery engine 42 reviews the primary advertisements 50 to determine which advertisements have been delivered. For ease of illustration, each of the advertisements have been sequentially numbered which will also be used as an indication of priority, with the number “1” indicating the highest priority. Accordingly, in response to a request 98, the system may first review the primary advertisements 50. In FIG. 6, a determination is made at block 51 whether all primary advertisements have been delivered. If Ad 1 has not been delivered, it is provided by the delivery engine 42 in response to the user request, as indicated by line 90 extending from Ad 1 to deliver ad 92 and line 94 extending from deliver ad 92 to the advertisement delivery system 10, and then on to the request 96 shown by line 98. “Deliver ad 92” is used herein generally for ease of reference to identify that the designated or selected advertisement illustrated in FIG. 6 will be delivered to the advertisement delivery system 10 for delivery by the delivery engine 42 in response to the user request 96, as further identified by lines 94 and 98. If Ad 1 has been delivered, the system proceeds to determine whether Ad 2 has been delivered, and if not, it is delivered to the advertisement delivery system 10 for satisfaction of the request 96. If Ad 2 has been delivered, the system similarly proceeds to determine whether Ad 3 has been delivered, and if not, it is similarly delivered to the advertisement delivery system 10 for satisfaction of the request 96, and so forth. Additional primary advertisements (not shown) may be evaluated and delivered in the same manner.

If all of the primary advertisements 50 have been delivered, as determined at block 51 in FIG. 6 or after Ad 3 of the primary advertisements 50 has been delivered, the system reviews the second category 52 of advertisements at block 53 to determine whether all candidate advertisements 52 have been delivered. In the illustrated embodiment, the second category 52 includes the candidate ads. Similar to the primary ads, the candidate ads 52 may be reviewed for priority. Accordingly, if Candidate Ad 1 has not been delivered, it is delivered to the advertisement delivery system 10 for delivery by the delivery engine 42 in response to the request 98 as indicated by line 100 extending between C-Ad 1 and deliver ad 92, line 94 extending between delivery ad 92 and advertisement delivery system 10, and line 98 extending between the system 10 and the request 96. If Candidate Ad 1 has been delivered, the system proceeds to Candidate Ad 2 and determines whether Candidate Ad 2 has been delivered, and if not, it is delivered to the advertisement delivery system 10 for satisfaction of the request 96. If Candidate Ad 2 has been delivered, then Candidate Ad 3 may be evaluated and delivered in the same manner. Additional candidate advertisements (not shown) may be evaluated and delivered in the same manner.

If all of the candidate ads have been delivered, the third-level ads 54 may be reviewed or analyzed for delivery in the same manner. Accordingly, the advertisement delivery system 10 may first determine whether all third level advertisements have been delivered at block 55 in FIG. 6. The system may review each advertisement and deliver the appropriate ad based upon the priority of advertisement substantially as described with respect to the primary advertisements 50 and candidate advertisements 52. At the same time, the system may turn to additional categories or sources of advertisements when goals are met, in order to avoid over-serving advertisements or to satisfy other concerns.

In an alternative embodiment, the advertisements may be arranged for delivery on a dynamic scale. Namely, a minimum and a maximum number of impressions per day may be provided. In another exemplary embodiment, a minimum, a target, and a maximum number of impressions may be provided. These minimum and maximum values, as well as target values, may be set be contract, or by the website, or other factors. For example, a contract may state that 10,000 impressions must be delivered per day. Accordingly, both the minimum and the maximum number of impressions equals 10,000. Another contract may set forth the number of impressions required to be delivered may be between 1 and 50,000 impressions. In this case, the minimum number of impressions to be delivered per day is 1 and the maximum number of impressions is 50,000. A third contract may set forth between 100 and 1000 impression are to be delivered in one day, forming a minimum of 100 and a maximum of 1000 impressions. Using these minimum and maximum values, as well as or including target values, the advertisement delivery system 10, and in particular the delivery engine using an algorithm, calculates the priority for delivery. Priority may also be assigned as previously described hereinabove. Priority may be calculated using the following general logic. In each day, the goal of the system is to meet the minimum value, but as internet traffic volume increases, the goal is to reach the maximum value. Once the maximum value is reached, no further advertisements associated with that value are served. In another exemplary embodiment, the system, and in particular the delivery algorithm may attempt to first reach minimum goals, then target goals, then maximum goals based upon priority assigned within each goal range, e.g., within minimum goals, target goals, and maximum goals. A scalability factor may be introduced, such that high risk ads, or high priority ads, are delivered. For example, in the alternative embodiment described, the advertisement with the higher minimum value may be served before the advertisement with the lower value minimum. Thus, to increase the likelihood that an advertisement will be served, the minimum value for a particular advertisement may be increased. This may occur in situations where targeting factors are narrow, or where a low volume of traffic or below predicted volume of traffic is expected to a particular site. While specific examples are provided, any purposes suitable for the delivery of advertisements may be acceptable for the purposes of the present invention. The advertisement system may monitor it's own delivery throughout a designated time period to dynamically weight or prioritize the advertisements to reach an appropriate threshold, such as for example, the minimum, target, or maximum goal.

In operation, a user may access the internet through a wireless or hardwire connection through a personal computer, mobile device, or other electronic device with connectivity to the internet or intermittent connectivity to the internet, such as an MP3 player or the like. The device includes a computer screen for viewing a webpage or advertisement. The user enters relevant information directly or indirectly for a website. A user requests an internet website 20 by entering the relevant address into a browser. This request may be transmitted to the web server 30. The web server 30 submits the request to the ad server 40, or a request may be made from the website 20 to the ad server 40, to determine an appropriate advertisement to insert into a webpage in response to the request.

The user who meets the targeting parameters pulls up the relevant website. Using the web server 30 and ad server 40 described herein, based upon the user request, the configuration module 44 queues the scheduled advertisements for delivery by the delivery engine 42. The delivery engine 42 and configuration module 44 make a determination regarding an appropriate advertisement to deliver to the user. For example, the user and the request may be evaluated against the various targeting parameters or other features of that particular website 20. The system also evaluates any applicable priority information and internet traffic flow to determine an appropriate advertisement to deliver. In the exemplary embodiment, the advertisement delivery system 10 first looks to the primary ads. The system works on the delivery engine 42 so that internally, when a user clicks on the particular website 20, the website may recognize the user and user properties. It reviews the advertisements for the priority ad to deliver to the user based upon this information available for the user. If no primary ads are available for delivery to the user, the advertisement delivery system 10 looks to the secondary and third level ads for delivery as described herein.

If the user matches the relevant parameters, the user may be served an advertisement that matches and is available for delivery. In FIG. 6, there are three potential advertisements that match, namely, Ad 1, Ad 2, and Ad 3. These advertisements may also be available for delivery to one or more additional users not specifically illustrated in FIG. 6. Advertisements which have not yet been delivered are available for delivery to the user. If more than one advertisement is available, the advertisement may be delivered according to a priority determined as described herein. For instance, if Ad 1 has been delivered, then it would not be queued for delivery to the user. If Ad 1 has not been delivered, then Ad 1 may be served to the user. The same analysis applies equally to Ad 2 and Ad 3. In the illustrated example, Ad 1 has highest priority, followed by Ad 2 and then Ad 3. The higher priority advertisement may be delivered before the lower priority advertisement in this example. Therefore, Ad 1 would be served before Ad 2 or Ad 3, and Ad 2 would be served before Ad 3. Assuming that each of Ad 1, Ad 2, and Ad 3 are available for delivery, then Ad 1 may be delivered to the user. The system inserts one of the advertisements into the engine. The delivery engine 42 then delivers the advertisement that matches targeting parameters, delivery goals, and priority information, according to an algorithm, leaving a remaining number of advertisements or impressions for display upon additional requests. The advertisement may be delivered to the web server, placed into the webpage at the designated location and rendered for the user. In other words, the advertisement may be delivered to the ad server 40, as assigned by the delivery engine 42 and configuration module 44, which provides the ad to the web server 30 or directly for placement into the web page 20. The web page may be then rendered for the user on the internet website. The system recognizes that it has fewer advertisements remaining, thus, undelivered Ads 2 and 3 may be served in response to a future request.

### EXAMPLES

The following examples are presented as illustrations of the advertisement delivery system and are not intended to limit the overall scope of the present invention.

### Example 1

A first exemplary illustration of the advertisement delivery system 10 is provided. In this embodiment, the website is a sports media or sports oriented website.

In this example, the delivery engine 42 operating with a configuration module 44 is provided with a planned number of impressions. Specifically, for purposes of example, the configuration for one hour of one day, such as over the noon hour, includes Ad 1, which is associated with a contractual obligation to deliver 10,000 impressions on the sports oriented website in the hour. Ad 2 is also included in the configuration, which includes a contractual obligation to deliver 50,000 impressions of the Ad to users interested in football, which may be included in the sports oriented website. Ad 3 is included in the configuration and includes a contractual obligation to deliver 1,000 impressions of the advertisement to users from California who are interested in football, which may also include the sports oriented website. Accordingly, each Ad has a goal, namely, the goal for Ad 1 is 10,000 impressions, the goal for Ad 2 is 50,000 impressions, the goal for Ad 3 is 1,000 impressions. Each Ad is also assigned a priority. Priority may be assigned using any suitable criteria determined by the website operator. In the present case, Ad 1 will be provided with Priority 1, Ad 2 will be provided Priority 2, and Ad 3 will be provided Priority 3. Accordingly, for the noon hour, the plan provided to the configuration module for delivery includes 61,000 impressions, to be distributed in the priority order described above.

At a time period within the hour, the advertisement delivery system 10 reviews the plan and the delivered advertisements and makes a determination of which advertisements to deliver for the remainder of the hour. Accordingly, in this Example, at 30 minutes, the advertisement delivery system 10 determines that 1,000 impressions of Ad 1 have been delivered, 5,000 impression of Ad 2 have been delivered, and 1,000 impressions of Ad 3 have been delivered. As a result, the delivery goal for Ad 3 has been met. Ad 1 has 9,000 impressions remaining before its goal is met. Ad 2 has 45,000 impressions remaining before its goal is met. The advertisement delivery system 10 will stop serving Ad 3, and deliver the remaining ads from Ad 1 and Ad 2 in response to user requests. In this way the system will not over-serve Ad 3 and will attempt to maximize delivery of Ads 1 and 2 to attempt to reach the assigned goals in the time remaining.

### Example 2

In an alternative example, the configuration and Ads 1, 2 and 3 are as described in EXAMPLE 1. In this Example, however, at 30 minutes, the advertisement delivery system 10 determines that 1,000 impressions of Ad 1 have been delivered, 5,000 impressions of Ad 2 have been delivered, and 100 impressions of Ad 3 have been delivered. In this embodiment, the system will continue to serve Ads 1, 2, and 3 according to their priority. Accordingly, provided that the targeting parameters of delivery are met, the system would serve Ad 1 before Ad 2 and Ad 3, and Ad 2 would be served before Ad 3.

### Example 3

In a further alternative example, the configuration and Ads 1, 2 and 3 are described as provided in EXAMPLE 1. In this Example, however, at 30 minutes, the advertisement delivery system 10 determines that an internet traffic spike has occurred and the system has reached 61,000 planned impressions at the 30 minute mark. In this case, the advertisement delivery system will look to a secondary category of advertisements, such as the candidate ads, to deliver advertisements for the remainder of the time period. The advertisements may similarly be delivered according to their priority and goals.

Thus, in one example, an additional 60,000 impressions will be delivered within the remaining 30 minutes. Candidate Ad 1 may be a make-over deal requiring advertisements to be delivered anywhere on the sports oriented website and requiring 30,000 impressions. Candidate Ad 2 may be a contractual general delivery advertisement, unrestricted in terms of placement or targeting, but requiring 30,000 impressions. Accordingly, Candidate Ad 1 and Candidate Ad 2 are served in response to user request to fulfill the remaining 60,000 impressions within the hour.

### Example 4

In a further alternative example, the configuration, Ads 1, 2 and 3, and Candidate Ads 1 and 2 are described as provided in EXAMPLE 3. However, the number of additional impressions is lower, for example, only 30,000 additional impressions are available. As a result, Candidate Ad 1 and Candidate Ad 2 will be served in response to user request based upon priority and goals. For instance, Candidate Ad 2 may have higher priority and be served prior to delivery of Candidate Ad 1.

### Example 5

In a further alternative example, configuration, Ads 1, 2 and 3, and Candidate Ads 1 and 2 are described as provided in EXAMPLE 3. However, the number of additional impressions in the remaining 30 minutes is 600,000 impressions. As a result, Ads 1, 2, and 3, as well as Candidate Ads 1 and 2 will be served in their entirety. The remaining number of additional impressions can be filled by additional advertisements obtained from a third-level category. For example, an additional 540,000 advertisements may be obtained from TL Ad 1, TL Ad 2, or TL Ad 3, each of which are arranged for delivery and may be arranged for delivery according to a priority or goal similar to that described in the previous Examples. In this manner, the spike in internet traffic may be handled dynamically by use of additional resources of impressions.

As can be seen from the foregoing description of exemplary embodiments, the advertisement delivery system, is able to maximize usage of available advertisement space and to adjust for low levels of internet traffic to deliver advertisements according to business preferences. Thus, the system and method may minimize risk associated with overestimates of internet traffic flow and may take advantage of high internet traffic volumes to, for example, increase revenue. More specifically, in an exemplary embodiment of the advertisement delivery system can assist in fulfilling contractual obligations or guarantees for ad delivery and effectively use the advertising space available. The system interacts, in real time or near real time, at the delivery engine level to direct, establish, and monitor internet traffic flow and availability of advertisements with a level of precision. The system with the foregoing components enhances the effective use of available online advertising space.

Although various representative embodiments of this invention have been described above with a certain degree of particularity, those skilled in the art could make numerous alterations to the disclosed embodiments without departing from the spirit or scope of the inventive subject matter set forth in the specification and claims. In some instances, in methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to preferred embodiments, persons skilled in the art will recognize that changes may be made in form and detail without departing from the spirit and scope of the invention.

What is claimed is:

1. An advertisement delivery system for internet advertising comprising:
an ad server in functional communication with a delivery engine capable of delivering an advertisement to a web server for display in a webpage in response to a triggering event by an internet user;
a configuration module in functional communication with the delivery engine, the configuration module adapted to schedule an advertisement for delivery by the delivery engine, the configuration module capable of communicating the advertisement to the delivery engine according to the schedule, the configuration module having a schedule of advertisements for display in a defined period of time;
means for calculating in real time internet traffic flow; and
means for adjusting the schedule of delivery of advertisements based upon the internet traffic flow.

2. The advertisement delivery system of claim 1, wherein the internet traffic flow is less than a predicted value, and wherein the means for adjusting the schedule of delivery of advertisements is adapted to deliver advertisements according to a priority.

3. The advertisement delivery system of claim 2, wherein each advertisement in the schedule of advertising is arranged for delivery in order of priority.

4. The advertisement delivery system of claim 1, wherein the internet traffic flow is greater than a predicted value and the advertisements scheduled for delivery from a primary set of advertisements, and wherein the means for adjusting the schedule of delivery of advertisements is adapted to deliver advertisements from a secondary set of advertisements.

5. The advertisement delivery system of claim 4, wherein the secondary set of advertisements is arranged for delivery in order of priority.

6. The advertisement delivery system of claim 4, wherein the means for adjusting the schedule of delivery of advertisements is adapted to deliver advertisements from a third set of advertisements.

7. The advertisement delivery system of claim 1, wherein the triggering event comprises a request received by the web server from the internet user for a website.

8. The advertisement delivery system of claim 1, wherein the means for adjusting the schedule of delivery of advertisements is adapted to include a consideration of advertisement targeting parameters.

9. An advertisement delivery system for internet advertising comprising:
an ad server in functional communication with a delivery engine capable of delivering an advertisement to a web server for display in a webpage;
a configuration module in functional communication with the delivery engine, the configuration module adapted to schedule an advertisement for delivery by the delivery engine, the configuration module capable of communicating the advertisement to the delivery engine according to the schedule, the configuration module assigning a first set of advertisements to a first priority list and assigning goals for delivery to the first set of advertisements, and assigning at least a second set of advertisements to a second priority list and assigning goals for delivery to the second set of advertisements, the first set of advertisements being adapted to be delivered before the second set of advertisements.

10. The advertisement delivery system of claim 9, wherein the delivery engine is capable of delivering the advertisement to the web server for display in the webpage in response to a triggering event by an internet user.

11. The advertisement delivery system of claim 10, wherein the triggering event comprises a request received by the web server from the internet user for a website.

12. The advertisement delivery system of claim 9, wherein the delivery engine is adapted to deliver an advertisement from at least one of the first and second priority lists based upon internet traffic deviation from a predicted value.

13. An advertisement delivery system for internet advertising comprising:
an ad server in functional communication with a delivery engine capable of delivering an advertisement to a web server for display in a webpage in response to a triggering event by an internet user;
a configuration module in functional communication with the delivery engine, the configuration module adapted to schedule an advertisement for delivery by the delivery engine, the configuration module capable of communicating the advertisement to the delivery engine according to the schedule, the configuration module having a schedule of advertisements for display in a defined period of time; and
the delivery engine arranged to calculate in real time internet traffic flow and communicate with the configuration module to adjust the schedule of delivery of advertisements based upon the internet traffic flow.

14. A method of advertisement delivery for internet advertising comprising:
obtaining a plurality of advertisements for delivery in response to a triggering event by an internet user;
assigning goals for allocation of a first set of advertisements in relation to the triggering event;
assigning goals for allocation of a second set of advertisements in relation to the triggering event;
assigning a priority to advertisements in the first set of advertisements;
receiving a request for delivery of an advertisement;
selecting an advertisement for delivery based upon a goal of the advertisement, a priority for the advertisement and internet traffic flow;
delivering the selected advertisement.

15. The method of claim 14, wherein the internet user is delivered an advertisement from the advertisement inventory based upon a match with pre-defined targeting criteria.

16. The method of claim 14, wherein when the request for delivery of an advertisement is received, goals of advertisements in the first set of advertisements are met, and internet traffic flow is greater than a predicted amount, selecting an advertisement for delivery from the second set of advertisements.

17. The method of claim 14, wherein when the request for delivery of an advertisement is received and internet traffic flow is less than a predicted amount, selecting an advertisement for delivery from the first set of advertisements according to the assigned priority.

18. A method of advertisement delivery for internet advertising comprising assigning a minimum number of impressions of a plurality of advertisements to be delivered based upon user request, assigning a maximum number of impressions to a plurality of advertisements to be delivered based upon user request, delivering impressions of advertisements in response to a triggering event by an internet user to meet the minimum number of impressions, and terminating advertisement delivery based upon reaching the maximum number of impressions.
